(19) United States
(12) Patent Application Publication
(10) Pub. No.: US 2006/0182673 A1
(43) Pub. Date: Aug. 17, 2006

(54) Apparatus for heterogeneous catalysed reactions

(76) Inventor: John Richard Hensman, HERTFORDSHIRE (GB)

Correspondence Address: ARENT FOX PLLC, 1675 BROADWAY, NEW YORK, NY, 10019, US

(21) Appl. No.: 10/504,092

(22) PCT Filed: Jan. 23, 2003
(86) PCT No.: PCT/GB03/00269

§ 371 Date: Jul. 7, 2005

(30) Foreign Application Priority Data
Feb. 11, 2002 (GB) 0203182.1

(51) Int. Cl. B01J 19/00; B01J 8/08; B01J 8/18

(52) U.S. Cl. 422/198; 422/139; 422/219; 422/224

(57) ABSTRACT

Apparatus for heterogeneous catalysed reactions for converting a gas to a liquid or liquids comprising a reactor shell suite for containing a slurry of a particulate catalyst in a liquid and having a gas outlet; a heat exchange system comprising one or more heat exchangers located within the reactor shell; means for removing at least a portion of the slurry from a reaction zone of the reactor shell and means for reintroducing the slurry into the reaction zone after it has been mixed with gas; a multi-phase mixing device for mixing slurry and gas; mean to distribute the slurry reintroduced into the reaction zone equally across a cross-section of the reaction zone; and means to prevent variation in concentration of gas in a cross-section of the reaction zone.

The present invention relates to apparatus which is particularly suitable for use in the conversion of gaseous hydrocarbon feed to liquid product.

It is often desirable to convert a gaseous feed to a liquid product as the liquid product can generally be transported and handled more easily than the gas from which it was produced. There are several chemical reactions by which such gases may be converted. One example of this is the production of methanol from synthesis gas. A second example is the Fischer Tropsch process by which synthesis gas is converted to a liquid hydrocarbon product using a suitable catalyst. Synthesis gas is a gas containing hydrogen and carbon monoxide which can generally be obtained by the conversion of natural gas and thus, the Fischer Tropsch process may be used to convert the natural gas that is found in large supply in many regions of the world to usable liquid fuel.

In processes for the conversion of gas to liquid, there is a need for satisfactory reactor design which overcomes the many problems that may arise in the conversion process. These problems, which are well known in the field of reactor design, include: the need to remove the heat of reaction whilst maintaining temperature control; the need to minimise variations in temperature within the body of the reactor; the need to avoid a large pressure drop in the gas flowing through the reactor; a requirement to reduce gas compression costs and maintain adequate reaction rates per unit volume; a requirement to maintain suitable reactor concentrations to achieve adequate reaction rates per unit volume while maintaining reaction selectivity to the desired products and satisfying the mass balance requirements that the feed rates of the components should approximate the rate of reaction of the components; and controlling reactor operating conditions so that catalyst activity is maintained.

For Fischer Tropsch processes two principle types of reactor have been studied. These are the tubular fixed-bed reactor and the fluidised reactor in which the catalyst is suspended in liquid through which the reaction gases flow. Each of these reactor types addresses some of the problems detailed above.

However, whilst the tubular fixed-bed reactor offers advantages in terms of providing spatially consistent conditions for the reaction process and of restricting mixing between the feed and the reactant gas, it suffers from various disadvantages when used on a large scale. In particularly, unless a large catalyst particle size is used a high pressure drop is noted. However, it is not generally advantageous to use a catalyst having a large particle size since this will limit the reaction rate per unit volume of catalyst, and will reduce the selectivity of the reaction to the desired product. In addition, a large surface area of heat exchange is required to remove heat from the catalyst and this means that the reactor is expensive to construct and operate.

The advantage of the fluidized catalyst reactor is that small catalyst particles can be used without giving rise to large pressure drops in the reactor. Further, improved heat transfer can be achieved which will result in lower operating costs for the reactor. However, the fluidised reactor does suffer from various problems. Although many designs have been proposed which appear promising when utilised on a laboratory scale, problems are still encountered when moving to a commercial scale. These problems include lower rates of production and poorer selectivity than expected. It has become apparent that there are three main causes of the reduced performance experienced in large scale fluidized reactor designs. The first is the result of segregation of the catalyst within the fluidised bed which arises from an uneven distribution of catalyst throughout the volume of the reactor in which reaction is to occur. The second problem is due to variation in the concentration of reactants which occur within the reactor and the third is due to variations in temperature which occur in the reaction system. The occurrence of one or more of these problems will have a detrimental effect on the performance of the process.

For example, if a high catalyst concentration occurs in an area of the reactor having a high concentration of reactants then a high rate of reaction will occur which will give rise to a high rate of heat generation which in turn will give rise to high local temperatures which will reduce the selectivity of the reaction. Conversely, if a high catalyst concentration occurs in an area of the reactor having a low concentration of reactants then a low rate of reaction will occur and the efficiency of the reaction will be reduced. Further, catalyst deactivation may be promoted by undesirable variations in the operating conditions within the reactor.

For example, where a Fischer Tropsch process is carried out over a cobalt based catalyst, it is desirable that the ratio of hydrogen to carbon monoxide should be close to the optimum value at the surface of the catalyst throughout the volume of the reactor in which reaction is to occur. However, this ratio is generally not equal to the ratio at which the gases are consumed. Therefore the local concentration at the catalyst surface is a function of the general flow patterns of the gas and liquid of the reactor, the rate of diffusion of the reactants through the liquid, the local concentration of catalyst, the local interfacial area between the gas and the liquid, and the local temperature, as well as the feed gas ratio. Similarly, the temperature at any point in the reactor will be a function of these variables and the distance from nearby heat transfer surfaces and the temperature of these surfaces.

There have been many suggestions for overcoming these problems. In U.S. Pat. No. 5,348,982 there is a suggestion that a slurry bubble column design may be used to achieve a distribution of reactant concentration that approximates to a plug-flow reactor by restricting gas velocities. In this connection, it is noted that in conventional slurry bubble column reactor systems, although a gas distributer may be present to distribute the gas across the width of the reactor, at commercial scale gas flows, the gas tends to flow towards the centre of the reactor or up-flow zone as it travels upwardly through the catalyst slurry. This means that the volume of gas exposed to catalyst in the outer regions of the reactor is less than that exposed to catalyst in the centre of the reactor at the same level.

United Kingdom patent application no. 0023781.8 which was filed on 28 Sep. 2000 and which is incorporated herein by reference describes a reactor for use in a Fischer Tropsch reaction in which in one embodiment the size range of the catalyst particles is controlled and flow conditions in the reaction vessel are maintained at a sufficient level to establish a circulation pattern throughout the vessel. The circulation pattern includes an up-flowing path of slurry and a down-flowing path of slurry such that the reaction vessel is substantially devoid of stagnant zones in which the catalyst particles can settle out of the slurry.

An alternative approach is described in WO-A-01/38269 in which a process of the conversion of synthesis gas to higher hydrocarbons is described which comprises a high shear mixing zone and a post mixing zone. In particular the process comprises passing a suspension of catalyst in a liquid medium through the high mixing zone where it is contacted with the synthesis gas. The mixture of synthesis gas and suspension is then passed to the post-mixing zone where at least a portion of the synthesis gas is converted to higher carbons to form a product suspension including catalyst and product. A portion of this suspension is then recycled to the high shear mixing zone. In addition, unconverted synthesis gas is separated from the product stream and recycled to the high shear mixing zone.

In U.S. Pat. No. 6,060,524 there is a suggestion that liquid circulation can be used to improve the performance of a reactor by avoiding the problem of catalyst sedimentation.

Whilst these proposed reactor designs go some way to overcoming the problems detailed above, there is still a need for a design which successfully overcomes at least the majority of the problems associated with known reactors and which can be successfully operated in a large scale reactor at a commercial level.

Thus the present invention relates to a novel combination of feature which surprisingly interact with each other in such a manner as to overcome the complex and interactive problems which occur in conventional reactors for multiphase reaction systems.

Thus according to one aspect of the present invention there is provided apparatus for heterogeneous catalysed reactions for converting a gas to a liquid or liquids comprising:
a reactor shell suitable for containing a slurry of a particulate catalyst in a liquid and having a gas outlet;
a heat exchange system comprising one or more beat exchangers located within the reactor shell;
means for removing at least a portion of the slurry from a reaction zone of the reactor shell and means for reintroducing the slurry into the reaction one after it has been mixed with gas;
a multi-phase mixing device for mixing slurry and gas;
means to distribute the slurry reintroduced into the reaction zone equally across at least apart of a cross-section of the reaction zone; and
a plurality of flow channels to prevent variation in concentration of gas in a cross-section of the reaction zone.

By ‘reaction zone’ we mean any region of the reactor shell in which reaction may occur.

The apparatus of this invention is able to address the problems of the prior art reactors and may be economically and satisfactorily operated on a commercial scale.

The reactor shell may be envisaged as being divided into a number of zones. It will be understood that these zones are not physically separated one from another but simply occur due to, and are characterized by, the flow characteristics within the zone.

The reactor shell will generally be oriented with a vertical axis and for ease of understanding, the following description assumes this orientation. However, it will be understood that the reactor could, for example, be placed in a horizontal orientation It will therefore be understood that references to “up” and “down” could be replaced with references to “left” and “right” and the reverse.

In use, the slurry will be caused to circulate within the reactor shell as described below and this will mean that there will be an upflow region and a downflow region. The upflow and downflow regions may each be a section of the reactor's vertical volume. These sections may be segments of the reactor, and most preferably, there will be an annular arrangement such that, for example, the slurry will travel upwardly in a central region and there will then be an area of downflow around the central region. Similarly, upflow may occur in the outer region and downflow in the central region.

As will be described in detail hereinbelow, the upward flowing slurry will be rich in gas and as the catalyst slurry travels upwardly through the reactor, the majority of reaction will occur in this region of upflow and which may be regarded as the main reaction zone. However, reaction may also occur in other areas of the reaction shell.

In general, the slurry and gas will be separated in the uppermost area of the reactor shell such that the slurry can then travel down the downflow area and unreacted gas may be removed. Thus the uppermost area of the reactor shell may be regarded as upflow and downflow gas separation zones. The gas separation zones may be physically separated from the portion of the reactor shell in which upflow/downflow occurs.

It will be understood that within the reactor shell there is a middle zone which includes the main part of the upflow region(s) and the main part of the downflow region(s). Above this will be the upflow and downflow gas separation zones as described above. Beneath the middle zone, there will be the bottom zones which are described below. In general, the reactor shell will be designed such that the middle zone forms the largest zone within the reactor.

At the base of the reactor, i.e. in the bottom zones, slurry flow reversal will occur and inlet gas containing slurry will be introduced into the reactor. Thus these bottom zones can be regarded as being comprised of a flow reversal zone or zones and one or more distribution zones. As with the separation zones, these may be separated from the portion of the reactor shell in which upflow/downflow occurs.

It will be understood that where the reactor shell is arranged in an horizontal configuration, the “upflow” direction will nominally be a forward direction and “downflow” will nominally be a reverse direction.

The gas separation zones in the uppermost region of the reactor shell may include means to reduce the gas flow into the downflow area. Any suitable means including a gas/liquid separator may be used. However, if the separation zones are in direct contact with the middle zones, baffles will be particularly suitable. It will therefore be understood that the slurry leaving the downflow region of the gas separation zone will have a lower gas content that than the slurry exiting the upflow middle zone into the gas separation zone.

Since the middle zone of the upflow region, which will generally represent the largest volume of the reactor shell, is where the majority of the reaction processes occur, the heat exchange surfaces will generally be located within this zone such that the heat of reaction may be removed. Where desirable, the heat exchange surfaces may extend into the downflow region. This is particularly advantageous where reaction is to also occur in the downflow region.

The heat exchange system and the surfaces thereof may be of any suitable configuration provided that it allows an upward flow of slurry with entrained gas between the heat exchange surfaces and where the heat exchange system extends into the downflow zone, the downward flow of slurry.

Where the heat exchange system comprises a plurality of heat exchangers, these are preferably of the same configuration. In accordance with conventional systems, the heat exchange system of the present invention will allow the heat of reaction to be removed from the reactor by heat exchange with a second fluid flowing within the, or each, heat exchanger. The second fluid is preferably a boiling liquid such as a water and steam system.

In a preferred arrangement, the, or each, heat exchanger may be formed from a plurality of elements. In particular, the configuration preferably allows that the dimensions of the surface of the heat exchanger are large when compared with the distance between adjacent elements of the heat exchanger. In one arrangement, the one or more heat exchangers may be one or more plate exchangers. In one alternative preferred arrangement, the one or more heat exchangers may be one or more spiral heat exchangers. However, it will be understood that any suitable heat exchange system may be used and therefore, for example, the heat exchanger may also be of a shell and tube design or may be in the form of coils or tube bundles.

The heat exchange system will preferably be located along the majority of the length of the middle zone. Desirably heat exchange surface will be provided so that the local temperatures are all maintained close to the average temperature of the reactor, preferably within 5° C. of the average temperature and more preferably within 2° C. of the average temperature.

Whichever type of heat exchangers are used, in a preferred arrangement, the or each heat exchanger will be located substantially vertically within the reactor shell. Orientating the cooling side of the heat exchanger substantially vertically within the reactor shell is particularly advantageous where the coolant fluid is a boiling coolant since the vertical orientation will favour removal of vapour generated by the coolant.

In the reactor of the present invention, the cross-sectional area of the zone or zones in which downflow occurs will not exceed the cross-sectional area of the heat exchange system in the upflow region of the reactor. The region of downflow will preferably form about 10% to about 80% of the upflow area of the system.

It will be understood that the, or each, heat exchanger will be connected by any suitable means to inlet and outlet means for the coolant fluid. Where a plurality of heat exchangers are present they may each have a discrete inlet and outlet for coolant or they may be connected by any suitable means to a common inlet and/or common outlet.

One benefit of the heat exchange system being located within the reactor is that the heat of reaction may be removed without any significant reduction in slurry temperature which may occur in prior art reactors where reactor liquid is withdrawn from the reactor to be passed through an external heat exchange system. The ability to maintain a uniform temperature within the reactor eliminates potential thermal instability which may be introduced in the apparatus described in prior art systems where reactants or products become absorbed at high concentration and at low temperature. In these prior art arrangements the subsequent mixing operations, undesirable reactions may occur because heat transferred to the catalyst particle occurs more rapidly than the mass transfer of absorbed components on the catalyst. The undesirable reactions which may occur include for example methane formation or catalyst deactivation due to reactant concentrations at the catalyst surface which are not in equilibrium with the bulk of the liquid.

The reactor of the present invention includes means for removing at least a portion of the slurry from a reaction zone of the reactor shell and means for reintroducing the slurry into the reaction zone after it has been mixed with gas. Any suitable system may be used. In a preferred embodiment of the present invention a ducted circulation system may be provided. This ducted circulation system may be internal or external of the reactor shell. The circulation system will generally include a pump and any pump suitable for pumping slurry may be used. The pump will generally be of a centrifugal or axial design. The volume of liquid circulated by the pumping of device will generally be controlled to meet the requirements of the mixing device but will preferably at least be equal to the volumetric flow of a feed gas at the operating pressure. More preferably it will be capable of pumping 1.5 times the volumetric flow of the feed gas at the operating pressure. The pumping device will preferably provide sufficient pressure or heat to overcome the resistances to fluid flow in the recycling loop including resistances generated by the mixing device.

The mixing device is preferably a high-shear mixing device and will generally be a venturi device which will comprise three main elements. Slurry removed from the reaction zone of the reactor shell is passed to the mixing device and will generally enter through a nozzle or other restriction. This will generally have a reduced area from the inlet pipe. The nozzle or restriction will discharge into a throat or mixing length which will generally be of a larger diameter than the nozzle or restriction and which will also allow gas to enter in the direction of flow through the nozzle. Thus it is in this region that the slurry is first contacted with the gas. Following the throat there will normally be a diffuser which may be formed as a cone and which serves to increase the flow area in the direction of flow. Optionally a device to create a swirling motion in the liquid coming through the nozzle may be present. This may be of particular advantage where the venturi device is orientated horizontally.

The nozzle may be of any suitable diameter but is preferably arranged such that the circulated slurry will flow at not less than 8 m/s and preferably not less than 12 m/s through the nozzle. However, the flow rate of slurry through the nozzle will preferably be less than 30 m/s as large pressure drops may be noted at higher velocities. An example of a suitable mixing means is described by R. G. Cunningham in the Journal of Fluids Engineering, September 1974, pages 203 to 214 to form a venturi system.

If a venturi system is used, it may also include a device to create swirl in the liquid entering the device. It will be understood that the mixing device may be orientated vertically or horizontally and may be subdivided into parallel subunits. In one arrangement, the mixing device will be situated at a small distance from a slurry inlet to the reactor. However, in one arrangement the the mixing device is arranged to be located so that the discharge is piped internally through the reactor.

An alternative mixing device may be a design including static devices which provide rapid changes of flow direction such as that illustrated in FIGS. 19 to 39 of Perry's Chemical Engineers Handbook, 5th Edition. Alternative mixing devices include turbines or other rotating devices.

The flow leaving the mixing device will be a slurry of the catalyst in the liquid with the gas intimately mixed therewith. On exiting the mixing device, this mixture must be distributed substantially evenly across at least a portion of the cross-section of the reaction zone in a manner such that it is evenly mixed with the internally circulating flow from the downflow zone of the reactor. Any suitable distribution device may be used to prevent uneven gas and slurry flow.

The means to distribute the reintroduced slurry may simply be the outlet from the pipe from the mixing device. In one alternative arrangement, a separate distribution device may be used. In another alternative arrangement multiple mixing devices may be used, each of which has an outflow to a different area below at least a portion of the reaction zone.

Once the gas and slurry mixture has been fed to the at least a portion of the reaction zone equally across its cross-section, it is important that the gas is prevented from migrating towards the centre of the middle zone during its upward path and therefore means to prevent variation in concentration of the gas across the cross-section of the middle zone are introduced. These means may be provided at least in part by the heat exchange surfaces or exclusively or in part by dividers which serve to separate the central upflow zone into multiple segregated flow channels. Thus it will be understood that it is an additional benefit of the internal heat exchange system that the surfaces of the heat exchange system may contribute to the formation of the channels. The number of dividers and/or heat exchanger surfaces provided should preferably be sufficient to give a cross-sectional area for the flow in each channel of less than or equal to 0.1 m² and most preferably less than or equal to 0.006 m².

The presence of these channels in the arrangement of the present invention assists in ensuring even distribution of gas throughout the length of the upflow region of the middle zone. Thus, the channels prevent lateral migration of the gas towards the centre of the upflow region and thereby overcome many of the problems associated with prior art arrangements. One advantage noted is that the surfaces of the channels provided by the dividers and/or heat exchangers produce small scale turbulence which is beneficial since it promotes transfer of the reactants from the gas phase to the liquid.

Where used, the dividers may be of any suitable configuration. Each divider may be constructed as a separate element. These separate elements may be held in position within the reactor by any suitable means for example with tie-rods. In an alternative arrangement, the dividers may be constructed as one or more corrugated, folded or otherwise shaped, sheets. These dividers are particularly suitable for providing channels in spiral or plate heat exchangers.

The provision of multiple channels formed by the heat-exchange surfaces and/or dividers prevents large scale lateral migration of gas. Furthermore, regions of rapid up-flow where gas proceeds rapidly through the reactor are avoided and thus better and longer contact between the gas and the liquid is achieved than is achievable in conventional open designs for reactors. This even distribution of gas and liquid flows throughout the reaction upflow zone of the reactor contributes to an even distribution of catalyst throughout the zone which in turn leads to even temperatures, compositions and reaction rates.

In order to achieve steady flow through the channels without high pressure drop, it is preferable to operate the apparatus with gas velocity as calculated from the inlet gas flow and free cross-sectional area of the upflow zone through the upflow region preferably from about 0.08 to about 0.4 m³ of gas per m² of flow cross-sectional area In a more preferred arrangement, the velocity is preferably from about 0.12 to about 0.2 m³ of gas per m² of flow cross-sectional area.

In a preferred arrangement there will be means for controlling the gas flow and gas pressure into the mixing device such that fluctuations in the gas flow to the mixing device are avoided. In the case of a venturi mixing device, these control means will prevent jetting of the liquid from the nozzle through the mixing tube. In a preferred arrangement, the fluid velocity through the nozzle of the venturi device is greater than 8 m/s. Fluctuations in gas flow and jetting may cause reduced mass transfer of reactants from the gas to liquid phase. In one arrangement the gas flow control may be achieve by a conventional control valve positioned in the gas feed line to the mixing device within 10 m of the mixing device and operated with more than a 0.15 bar pressure drop across the valve.

In order to control the internal circulation within the reactor from the upflow to the downflow and back to the upflow, there will preferably be means to control the quantity of liquid within the reactor. This may include means for detecting the quantity of liquid in the reactor which may be by a differential pressure device across the height of the reactor or a part thereof. In general there will also be a means of adjusting the flow of liquid taken from the reactor to achieve the required quantity of liquid within the reactor while removing the volume of liquid produced by the reaction.

In a reactor of the present invention in a vertical orientation, as the liquid level in the separation zone at the top of the reactor shell rises, higher internal slurry circulation will occur. Similarly, as the liquid level is reduced, the rate of slurry circulation will be reduced. An increase in internal circulation will improve catalyst distribution and give rise to more even temperatures throughout the reactor, but will also reduce gas residence time and increase reactant dilution at the reactor inlet. Thus, controlling the internal rate of circulation is a means to optimise the operation of the reactor. The optimum circulation flow may change with other operating circumstances. However, the liquid velocity in the reaction zone should preferably be not less than 75% of the unhindered settling velocity of particles in the reactor liquid which are of the mean size of the largest particles which preferably constitute 5% of the mass of the catalyst.

In order that the invention may be clearly understood and readily carried into effect some preferred embodiments will now be described, by way of example only, with reference to the accompanying schematic drawings, in which:

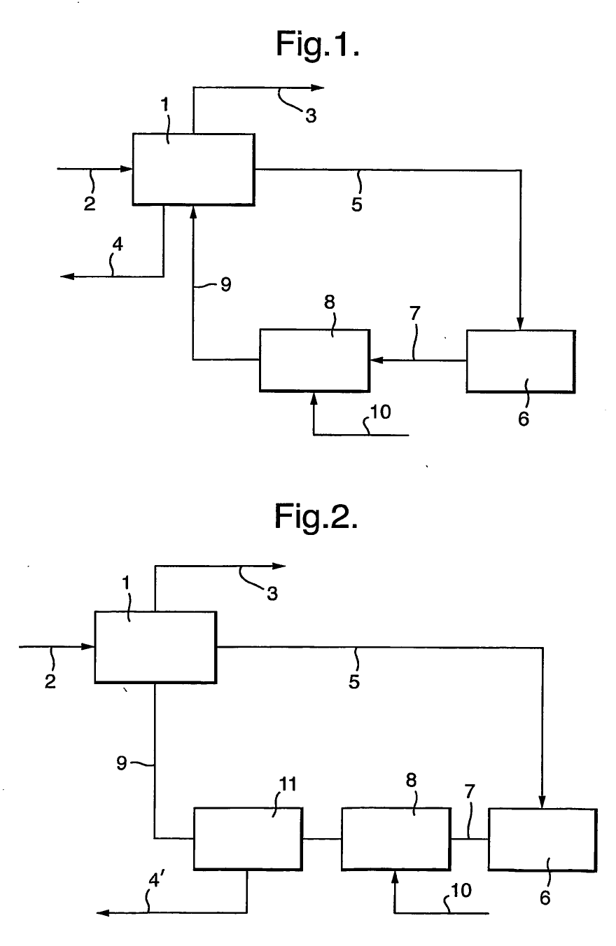

FIG. 1 is a block flow diagram of one arrangement of the apparatus of the present invention;

FIG. 2 is a block flow diagram of an alternative arrangement of the apparatus of the present invention;

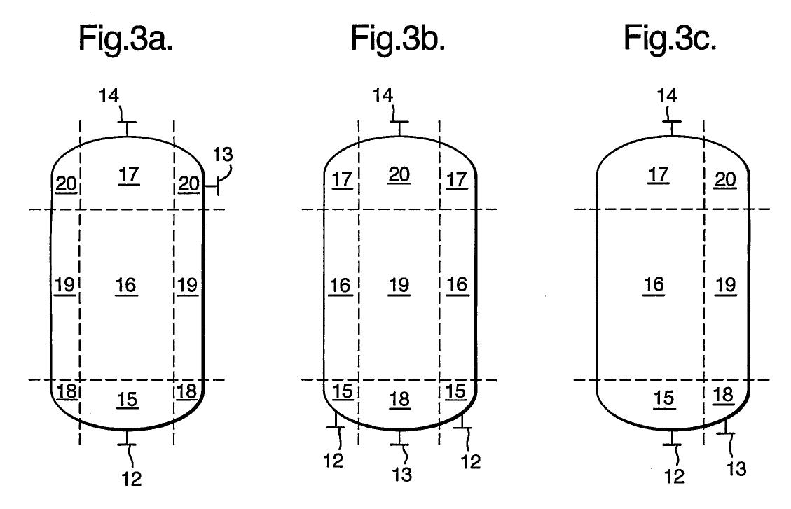

FIGS. 3a, b and c are schematic representations of the reactor shell illustrating the “zones” in different shell arrangements;

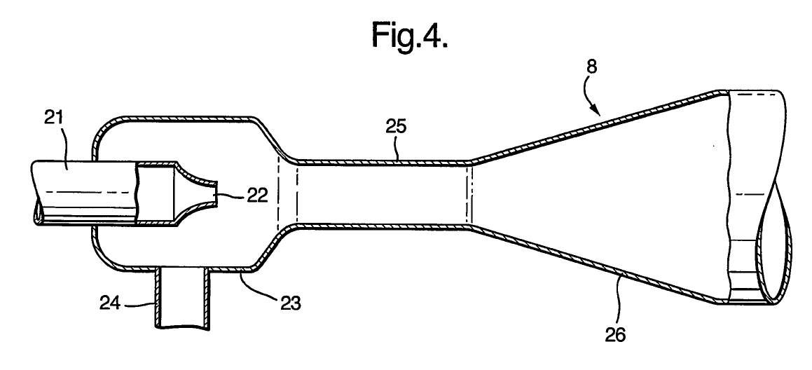

FIG. 4 is a schematic representation of one arrangement for the mixing device;

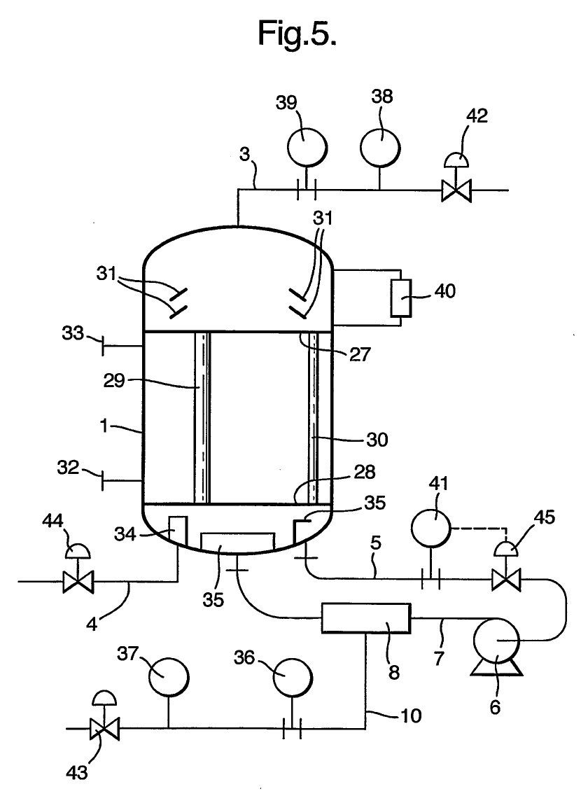

FIG. 5 is a schematic drawing of one arrangement of the present invention;

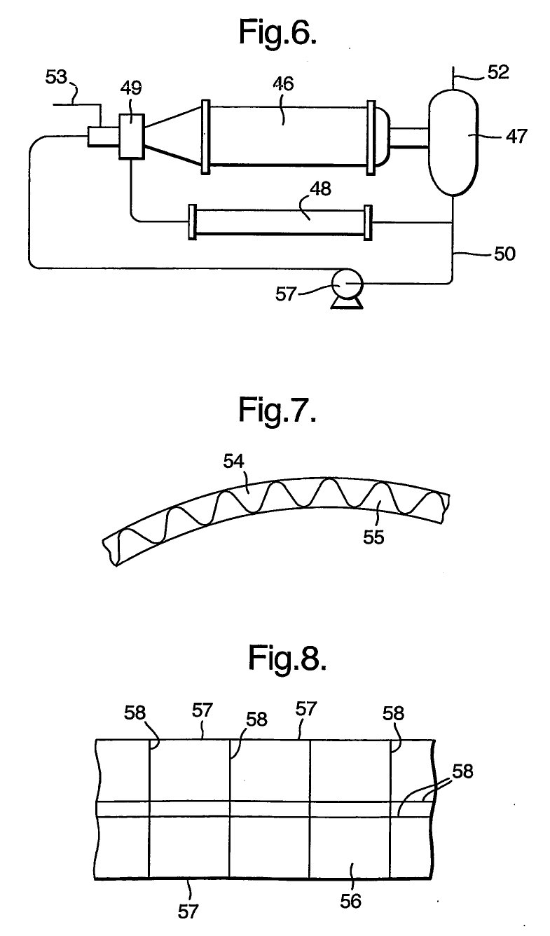

FIG. 6 is a schematic diagram of one alternative arrangement of the present invention;

FIG. 7 is a schematic diagram of the detail of one arrangement (from above) of dividers used with a spiral heat exchanger element; and

FIG. 8 is a schematic diagram of the detail of one alternative arrangement (from above) of dividers used with a plate heat exchanger element.

It will be understood by those skilled in the art that the drawings are diagrammatic and that further items of equipment such as feedstock drums, pumps, compressors, gas recycling compressors, temperature sensors, pressure sensors, pressure relief valves, control valves, flow controllers, level controllers, holding tanks, storage tanks, feedstock and catalyst preparation systems, product treatment systems, and the like may be required in a commercial plant. It will also be understood that the apparatus will include means for feeding gases, removing product and retaining catalyst with the reactor shell. Provision of such ancillary equipment forms no part of the present invention and is in accordance with conventional chemical engineering practice.

FIG. 1 shows a block flow diagram of the apparatus of the present invention. The apparatus comprises the reactor shell 1 into which a slurry feed may be fed via line 2. The reactor shell 1 will include means for removing the gas product 3 and the liquid stream 4. Either internal of the reactor shell 1 or as depicted in FIG. 1, external of the reactor shell 1, a stream 5 comprising slurry is separated and passed to a pump 6 for recycle to the reaction zone 1 via line 7, mixing device 8 and line 9. The gas feed, or at least a major proportion of the gas feed, is introduced into the slurry via line 10 to the mixing device 8 where it is mixed with the slurry.

It will be understood that the slurry feed 2 and the liquid product removal stream 4, rather than being located directly within the reactor shell, may each be located at any suitable place on the recycle loop formed by line 5, pump 6, line 7, mixer 8 and line 9. One example of a suitable arrangement may be found in FIG. 2 where a filter 11 has been inserted into line 9 such that the liquid product may be separated and removed in stream 4′.

As described above, the flow characteristics of the fluid within the reactor shell allow it to be envisaged as being divided into a number of zones. FIGS. 3a, 3b and 3c illustrate some examples of where these zones occur. FIG. 3a illustrates a reactor shell having an inlet 12 for the mixed gas and slurry flow from the mixing device, an outlet 13 for slurry flow to the pump and a gas outlet 14. This reactor can be envisaged as having six zones 15 to 20. Zones 15, 16 and 17 are upflow zones with zone 15 being the area in which the slurry and gas mixture are introduced into the reactor shell and distributed across the cross-section of the upflow zone. Zone 16 is the main middle zone in which the majority of the reaction will occur and which will include the heat exchange surfaces and the dividers to form the channels. Zone 17 is the gas separation zone. These central zones will be surrounded by the annular region notionally represented by zones 18 to 20 which form the downflow region. Zone 18 is the slurry flow reversal zone, 19 is the middle zone of the downflow and zone 20 is the gas separation zone.

Examples of alternative arrangements are represented in FIGS. 3b and 3c zones corresponding to those in FIG. 3a have been given the same identification numbers. FIG. 3b, like 3a, relates to an annular arrangement of the zones around a vertical axis. Here the upflow accors in the outer annulus and downflow occurs in the central region formed by zones 18 to 20. FIG. 3c represents one segmental arrangement where upflow occurs in one side of the reactor (illustrated in this case as being on the left) and downflow on the other (illustrated in this case as being on the right).

FIG. 4 represents a general arrangement of one suitable mixing device 8. This mixing device is a high-shear venturi device. The mixing device has an inlet pipe 21 through which the slurry will be introduced to the mixing device from the pump 6. The pipe ends with a nozzle 22 in a mixing chamber 23. Feed gas is fed into the mixing chamber 23 via the inlet 24. Usually, the inlet pipe will not end with a size reduction to form a nozzle. The gas and liquid are combined in the chamber 23 and then passed through a mixing length 25 and the into a diffuser 26 which is a conical section of pipe which increases in diameter at the area distal from the mixing pipe 25 to a size which corresponds to the diameter of the pipe 9 into which the mixed fluid will flow into the reactor shell.

FIG. 5 schematically illustrates an example of controls which may be used to control the hydraulic aspects of the apparatus. The reactor 1 illustrated is one having an annular conformation with the upflow occurring in the middle and downflow occurring in the annular ring around the middle. The reactor contains a tubular heat exchanger between a top tubesheet 27 and a bottom tubesheet 28. In the reactor of the present example, the heat exchanger extends in the upflow and downflow regions and therefore is throughout the central zone. For clarity only one tube 29 in the upflow region and one tube 30 in the downflow region are illustrated. However, it will be understood that a plurality of tubes will be present.

The reactor will also contain baffles 31 which will assist in the separation of the upflow zones from the downflow zones in the gas separation zones. In the arrangement illustrated, coolant may be introduced to the shell side of the heat exchanger. Gas is fed in line 10 to the mixer 8 and may be removed in line 3. Liquid product is removed in line 4 and an internal filter 34 will be provided to separate liquid from the catalyst. Slurry may be removed for recycle via line 5. In one arrangement it is taken from behind a baffle which will serve to reduce the gas content in the slurry removed from the reactor. Once the slurry is removed, it is passed via pump 6 to the mixer 8 where it is mixed with feed gas before being returned to the reactor 1 via a distributor 35 which will distribute the gas and slurry mixture across the cross-section of the central region and direct it into the channels which may be formed by the heat exchanger tubes alone or by a combination of the heat exchanger tubes and added dividers (not shown).

The controls present fall into two categories, namely those required to measure elements to provide the target values for the controllers and those which are the controlled variables and which are adjusted by the control system to achieve the required target values.

In the example of FIG. 5, the measuring controls are: the measurement of the gas flow to the mixer 36, the measurement of the pressure of the gas flow to the mixer 37, the measurement of the gas flow from the reactor 38, the measurement of the pressure of the gas flow from the reactor 39, the measurement of the quantity of liquid in the gas separation zone 40 (and may be, for example, a differential pressure or float device) and measurement of the liquid recycle flow 41.

The controlled variables are represented by control valves and include: the off-gas flow 42, the feed gas flow 43, the product flow valve 44 and the slurry recycle flow valve 45.

FIG. 6 illustrates one alternative reactor arrangement. Here the reactor is located in an horizontal arrangement. This reactor type will have structural advantages particularly with regard to transportation of the equipment. In this arrangement, the central zone channels would be provided with a mixing device along the length of the channel to reduce segregation of the gas and slurry within the channel. This device will generally be a spiral or series of spiral segments. In the specific arrangement of a horizontal reactor illustrated in FIG. 6, the reactor shell comprises an upflow reactor 46, a gas and liquid separation zone 47, downflow reactor 48 and a mixer 49. In this arrangement, a portion of the slurry separated will flow through the downflow reactor and a portion will pass in line 50 via the pump 51 to the mixer 49 which has an outlet directly into the reactor 46. Gas may be removed in line 52 and liquid in line 53.

FIG. 7 shows a diagrammatic example in plan view of how the channels 54 for the central up-flow zone can be constructed by means of a divider 55 within a spiral heat exchanger, and how the channels are formed by the combination of exchanger and divider surfaces. Similarly FIG. 8 illustrates an arrangement where a plate heat exchange is used. Here the channels 56 are formed by the plates 57, channel dividers 58 and tie rods 58.

The apparatus of the present invention may be used in a variety of reactions including the Fischer Tropsch process where, for example, a cobalt catalyst may be used.

For a Fischer Tropsch reaction of this type, the reactor will operate between a pressure of 180 and 240° C., a pressure of 10 to 40 bar, with a supported catalyst containing between 5 and 50% by weight cobalt, in a slurry of between 5 and 40% solid by volume in the reactor. Catalyst particle size is preferably less than 100 micron to provide a high activity and good selectivity.

1. An apparatus for heterogeneous catalysed reactions for converting a gas to a liquid or liquids comprising:
a reactor shell suitable for containing a slurry of a particle catalyst in a liquid and having a gas outlet;
a heat exchange system comprising one or more heat exchangers located within the reactor shell;
means for removing at least a portion of the slurry from a reaction zone of the reactor shell and means for reintroducing the slurry into the reaction zone after it has been mixed with gas;
a multi-phase mixing device for mixing slurry and gas;
means to distribute the slurry reintroduced into the reaction zone equally across a cross-section of the reaction zone; and
a plurality of flow channels to prevent variation in concentration of gas in a cross-section of the reaction zone.

2. The apparatus according to claim 1, wherein the heat exchange system is formed from a plurality of heat exchangers.

3. The apparatus according to claim 1, wherein the heat exchange system comprises plate exchangers, spiral exchangers, shell and tube exchangers, coil exchangers or tube bundles.

4. The apparatus according to claim 1, wherein the heat exchange system enables the average temperature of the reactor to be maintained to within 5° C. of the average temperature.

5. The apparatus according to claim 1, wherein the means for removing the at least portion of the slurry and reintroducing after mixing with gas occurs externally of the reactor shell.

6. The apparatus according to claim 1, wherein the multi-phase mixing device is a high-shear mixing device.

7. The apparatus according to claim 6, wherein the mixing device is a venture mixing device.

8. The apparatus according to claim 1, wherein the flow channels to prevent variation in concentration of gas are provided at least in part by surfaces of the heat exchange system to form channels.

9. The apparatus according to claim 1, wherein the flow channels to prevent variation in concentration of gas are provided at least in part by dividers to form channels.

10. The apparatus according to claim 8, wherein the cross-sectional area of each channel is less than or equal to 0.1 m².

11. The apparatus according to claim 10, wherein the cross-sectional area of each channel is less than or equal to 0.006 m².

12. The apparatus according to claim 1, wherein the apparatus provides for a gas velocity in an upflow region of the reactor shell to be from about 0.08 to about 0.4 m³ per m² of flow cross-sectional area.

13. The apparatus according to claim 12, wherein the apparatus provides for a gas velocity in an upflow region of the reactor shell to be from about 0.12 to about 0.2 m³ per m² of flow cross-sectional area.
